(19) United States
(12) Patent Application Publication
(10) Pub. No.: US 2008/0114980 A1
(43) Pub. Date: May 15, 2008

(54) System, method and apparatus for using standard and extended storage devices in two-factor authentication

(76) Inventor: Thangapandi Sridhar, Waltham, MA (US)

Correspondence Address: Thangapandi Sridhar, 85 Parkview Road, Waltham, MA, 02452, US

(21) Appl. No.: 11/598,341

(22) Filed: Nov. 13, 2006

(51) Int. Cl. H04L 9/32

(52) U.S. Cl. 713/168

(57) ABSTRACT

This invention relates to the use of, either a) common, non-proprietary, standard storage devices or b) storage devices with additional novel feature extensions, as a unique and secure authentication device to supplement the current password based authentication schemes. There are many personal devices with storage like Compact Flash or CF cards, Secure Digital of SD cards, Memory Stick, USB Flash hard drives, ipods, PDA's, Cell-phones or even digital Cameras in the market. They all have some kind of storage media (mostly flash media) and can be connected to networked computing devices to access the data stored in them. If these storage devices can be uniquely identified and related to the owner, then a lot of on-line applications like commercial transactions, secure access of on-line private data like bank account information, secure remote login into company's intranet etc., can get a very vital additional level of physical authentication (i.e. something you have in addition to something you know). However efforts at doing so immediately run into some seemingly insurmountable challenges. Guaranteeing global uniqueness of such devices and preventing the possibility of duplication of such a device or detecting quickly such duplicated devices are the major challenges. Most of the above devices except PDA's present themselves as simple, non-intelligent SCSI storage devices to a computer and the way they communicate to computers are subject to open SCSI standards and do not involve encryption. Due to this non-encrypted open nature (unlike the smart card standards) even if these devices have some globally unique serial number built-in, another device can quite easily fake this unique serial number with or without the help of some software. A lot of work is being done in SCSI standard for feature extension to provide encryption capabilities but all of them tend to focus on the security of the data stored rather making each drive unique and enabling them for being used in authentication. This specification provides some new ways a) to enable standard storage devices conforming to current SCSI standards for authentication by keeping a nonce on the device and varying with every transaction b) to extend the SCSI standard to provide the entire needs of authentication without the need for an elaborate hardware support or redesign of existing hardware, by dividing the media into easily administrable sections where read and write restrictions will be imposed by firmware.

Also this invention addresses one more major headache afflicting this industry. The currently available solutions like RSA's OTP (One Time Password) based SecureID and the USB tokens normally can be used for authenticating one device to one verifying entity or server which can lead to a condition called ‘token necklace syndrome’ where one will have to carry many of these dongles in his key chain for authentication to multiple institutions if those institutions insist on not going to third party or federated authentication.

The most important aspect of this invention is that these extensions needed to achieve two-factor authentication are quite easy to achieve without the need for any extra hardware support other than the normal CPU/Memory/IO that is already used to achieve the standard SCSI commands. With additional hardware support, or increased CPU power, speed, the storage devices can be extended to support any feature, but then they will suffer from additional cost, lower volume (normal storage devices are manufactured in very high volumes) and less market acceptance. For example, the many of the commonly available flash storage based drives use 8-bit microcontrollers with clock speed less than 100 Mhz and with random access memory few tens of kilobytes. The technology proposed here can very easily use such a processor and achieve the needs of two-factor authentication.

The current OTP solutions like RSA's SecureID etc. expect users to read a display and type them out to add to their password which is cumbersome but provides mobility whereas the current USB tokens, which can let a client program to read the OTP from USB tokens or other authentication information stored directly without user intervention, need prior installation of such client programs on the computing devices which in turn need administrative privileges to the computing devices. Most of the businesses restrict the administrative privileges to their computing devices and this lack of administrative privileges restricts the mobility of such USB tokens severely. But the storage devices, when they present themselves as devices having removable media (setting a corresponding bit in the SCSI INQUIRY command), can auto-launch the client software which can avoid the installation of client software. In addition many popular operating systems like Windows have built-in feature to let programs launched by non-administrative users to interact with the storage devices having removable media using the extended SCSI operations other than the normal READ and WRITE through a technique called SCSI PASS THROUGH. This driverless non-administrative-privilege authentication using the storage devices can 1) greatly enhance the mobility of the authentication devices, 2) let the users use other's computers without installing software or avoiding the possibility of leaving some data behind in their computer 3) provide the benefit of avoiding the need for users to read and type the OTP characters, 4) avoid the ‘token necklace syndrome’ and 5) avoid the need for third party federated identity management thereby helping to have total control of authentication of its users.

This specification is based on provisional patent application 60/736,185 dated Nov. 14, 2005 whose priority is claimed for this disclosure.

### AUTHENTICATION BY STANDARD STORAGE DEVICES

A new method explained here, that addresses the challenges of having a unique device and detecting fake device, can use even common, non-proprietary, standard personal storage devices without any smart feature or without proprietary SCSI extension for authentication. Currently the authentication devices need to keep one secret information shared with a verifying entity or authentication server program and another variable parameter that varies in synchronism with the said verifying entity or authentication server program based on time, event and other facts. But the new invention does not expect the device to change any parameter but the entire information and its randomness is directly controlled by the verifying entity or server. This new method involves a server program running in a secure host computer with access to a secure database that maintains a list of all the authorized users out of which a subset or all of the users are those who possess such an authentication device and enable this method of authentication to be used for their devices. The said server program will also have capability to generate hardware based random number or other ways to generate random or a pseudo random number that cannot be predicted. The server program will assign the user's device a random number (device nonce) as a “server assigned dynamic random device ID” that is good for one transaction and/or an event and/or a fixed duration of any length and keep this number also against the user in the said database. This “server assigned dynamic random device ID” is the key novelty to detect fake devices in a quick manner. The said server program will also prepare a “unique server string” about itself by generating a globally unique information about itself either by a hierarchical internet based naming system or by generating a Globally Unique Identifier (GUID) generation support of the operating systems. This “server assigned dynamic random device ID” assigned by the server will be kept on the user's storage device in a directory named after the “unique server string” with the help of the client program running on the computing device on which the user's storage device will be used. This client program can be a software service or a daemon installed (or provided by the operating system natively) and continuously running in the background of that computing device or a program launched automatically or otherwise out of the storage device and running as long as the such device is present or a program or script stored in the server that the user may download using his browser and permit it to run. Such a client program either by itself or through another program may also impose additional password or PIN based encryption of the “server assigned dynamic random device ID” before storing on the device or make use of password protected area of the device if the device already supports such an area. Also with such a client program, the communication between the verifying entity or server program and the client can be easily encrypted from end to end by many existing methods SSL, VPN etc. when the normally available SSL protection between the client's browser and the verifying entity or server is not adequate for any reasons like the presence of wanted or unwanted intermediaries. Also with “server assigned dynamic random device ID” being available in both the device and the server database, a bidirectional authentication can also easily be done by the well-known challenge-response method of authentication or in possibly other ways. To provide for communication issues, the server may maintain a few of the last used ID's and may positively authenticate a device even if it contains older ID's, thereby increasing the robustness and user friendliness while slightly enhancing the security risk window. Keeping this ID in a file located in a folder arrangement that reflects the “unique server string”, can enable one single device to be used for multiple verifying entities or server programs restricted only by the space available in the storage media. In addition the server program may also optionally keep all the possible hardware information like manufacturer name, model name, size, unique serial number if available etc., about the user's personal storage device in its database which may be verified during authentication.

### MALICIOUS ATTACKS AGAINST THE METHOD USING STANDARD DEVICES

Since the unique ID is stored as a file in the said device, if a malicious person or a malicious program with the knowledge of this method and SCSI protocol happens to get access to the device in any way, a possibility exists that he can recreate a fake device having exactly the same hardware information and exactly the same file. But he will still need the regular credentials like username/user-id and password. In case he has got those other credentials too, then also only if the malicious person logs into the account before account holder logs into his account with his personal device resulting in a new device ID, the malicious person will be granted access. But this very act of granting access will immediately invalidate the original owner's device ID present in his personal storage device. When the original owner tries to log in next time, he will notice that someone with the knowledge of his credentials has hijacked his device, and can initiate action to invalidate the hijacked device/trace the malicious user. But it may have to be noted, due to the unreliable transport mechanism of internet, many a time, the server may fail to update the device but may not know the failure and sometime it may have updated but may not be sure about the updating and to address this issue, the server may have to allow the authentication to succeed even if it contains the older device ID. Apart from providing some protection against fake devices, this method can protect against phishing attacks as long as the browser blocks websites from accessing the storage device as most of the current browsers do. If the device ID is stored with additional password encryption, when such a device is lost and recovered by one who is in possession of his password credentials to access the server program, cannot still use it for authentication unless he knows the password used for encrypting the device ID (note that the server password passes outside of the computing device but the password used for encrypting the device ID will mostly be a local one and will never go out). But if these devices are used in a computing device infested with malicious software that are aware of the methodologies used in this document, such malicious program can access the server program during a session when the device is present with such unauthorized access never getting detected, but will get detected if such program or its companion program tries to access the server program when the device is not present.

### AUTHENTICATION BY FEATURE EXTENDED STORAGE DEVICES

With a view to encourage innovation, SCSI standard has always had provisions for proprietary extensions of the standard by any vendor developing a storage device. New features can be added in this way to storage devices without conflicting with the standard commands. This document proposes a novel but simple extension to SCSI standard to address the needs of the authentication. The most important aspect of this invention is that these extensions are quite easy to achieve without the need for any extra hardware support other than the normal CPU/Memory/IO that is already used to achieve the standard SCSI commands. With additional hardware support, or increased CPU power, speed, the storage devices can be extended to support any feature, but then they will suffer from additional cost, lower volume (normal storage devices are manufactured in very high volumes) and less market acceptance. For example, the many of the commonly available flash storage based drives use 8-bit microcontrollers with clock speed less than 100 Mhz and with random access memory few tens of kilobytes. The technology proposed here can very easily use such a processor and achieve the needs of two-factor authentication.

One important need of authentication support is storage space that can not be read from the host computing device but can be written either only once or unlimited number of times from the host. In addition it may need storage space that can also be written and read back. The normal storage provided by SCSI devices can be written and read from the host computing device. If we want to provide both normal storage and authentication support, we need to support in the device a feature to divide the total storage media into at least two groups of fixed or variable sizes. The sizes of these groups may be controllable by the user and can be queried from the host by extended commands. One group would be for normal SCSI standard storage. The other group area needed for authentication can be a separate and continuous segment using consecutive sectors or can itself be divided into multiple groups with each group having different features like write-once-only, write-only and write-read etc. each of such sub-groups possibly being a continuous segment. Sometimes it may advantageous to have just one group for authentication and allocate variable or fixed area from it to every authentication server entity for keeping its authentication data and such area may contain entries that are having different features like write-once-only, write-only and write-read etc. The following explains an embodiment where there will be subgroups having different features but it does not restrict the scope of this invention if it is used in other ways.

In one embodiment the device firmware will have support to divide the total storage media into at least two groups but preferably four groups of fixed or variable sizes. The sizes of these groups may be controllable by the user and can be queried from the host by extended commands. They can be located anywhere, in any order in one or more of a single type of media or multiple types of media and can be part of the same SCSI logical unit numbers (LUN's) or in case of multiple LUN support being available, can be spread across one or more LUN's. Each group may be present as one single segment using consecutive sectors or may be split among multiple segments. But normally it will be easy to manage if each group occupies consecutive sectors/blocks of storage and positioned in order i.e. the first group takes first set of consecutive sectors, the second takes next set of consecutive sectors etc.

The first group, called normal storage group, is for the normal storage purpose and the same as in standard devices showing up as drive in the computing device. In case of single LUN containing all the groups, the size of this normal group is what will get reported to the host computer, as the available media size in response to the standard READ CAPACITY Command. Again in case of single LUN and sometimes even in multiple LUN case, the regular READ and WRITE commands will be limited to access this normal storage group only. In case of multiple logical unit numbers (LUN's) support being available in the computing device, it may be a preferred embodiment if this first group is kept as a separate LUN and all the rest are kept as another LUN (called authentication LUN).

The second group, called management group, is for management of other groups and managing authentication data. This area may also provide storage space for authentication server entity for data types that can be read from the computing host. This group can also contain information on how many authentication server entities have stored their registration information on the device and where that information is located. Sometimes this group may not be necessary.

The media area of the third group, called write-only group, can be written any number of times by the host sometimes writing being controlled through additional password based access control but can never be read from the host directly.

The fourth optional group, called write-once-only group, can only be written once by the host writing sometimes controlled through additional password based access control and can never be read from the host.

This “division of media into multiple special purpose groups to restrict host access” is the key to achieve the needs of authentication on the storage devices and this method is very easy, doable with only firmware modification and more importantly fully adequate to address the secure authentication needs.

The write-only and write-once-only groups will store the authentication information for the verifying entities or the server programs with which the owner of the device wants to register it for authentication, which can be a shared secret, a private key, a public key, a digital certificate or company information, logo or any combination of the above that needs to remain secret. Each such entity can request the device for allocation of a certain portion of the write-only group and/or write-once-only group and/or read/write area for keeping its authentication related information through a client program using extended commands. When allocating such space to any entity, the information about the entity and exact locations of the allocations will be maintained in the management group area so that they can be traced later when the server wants to use them for authentication. The management group will also track and maintain information about the full and ‘available for allocation’ sizes of the write-only and write-once-only and read-write groups. The sizes of the write-only, write-once-only and read-write (could be part of management group or be separate group in itself) groups will be so chosen that the device can store all the authentication information for all the verifying entities or server programs with which the user may like to register the device.

The READ and WRITE commands to any data area of any LUN will be validated at the device so that unauthorized access is not made to where it is not to be allowed. Normally write-once-only group will be used to store shared secret information or other secret information when the host computing device, to which extended storage device is attached, is known to be free of malicious software and is connected through a secure network to the authentication server that is in possession of the secret information. Some protocols such as CT-KIP of RSA can store secret information even in the presence of malicious software with some limitations and if those limitations are not of any consequences, the write-once-only area can also be used from a host that may have malicious software. Otherwise it may be advisable to use the write-only media and periodically changing the secret key until the device can be taken to a secure environment.

Though it is not strictly essential, better security can be provided if the device can support the access control protocol as described in SCSI SBP-2 standard by implementing at least the commands like Login/Logout/Set Password (probably in some implementations keeping the master password equal to an externally visible serial number may not be a good idea—but in those situations some suitable alternate arrangements like a random string as master password may be made). This access control can restrict some sensitive operations like initialization or registration of the device with a verifying entity or server program, deletion or overwriting of entries by any verifier entity or server programs, changing the sizes of the groups, updating of firmware etc. so that they can be done only when one logs in with a correct password.

To provide security against unauthorized firmware updating and making the non-readable media readable from the host, the firmware updating will either be disabled or controlled through some shared secret key or a public/private key pair kept in the write-only or write-once-only group and employing the well known challenge response method to authenticate the updating host, before proceeding with updating. As mentioned earlier the firmware up-gradation can be controlled by the password based login, should such feature is built-in.

The above extensions are the basic needs and then there would be more extensions depending on the kind of authentication technology to be implemented.

At the manufacturer's site, a vendor code, a device serial number and an true random number can also be programmed into the device in the write-once-only group, though in some implementations this may not be needed.

In addition optionally a free running counter not readable from host with random start value and another random increment value by which the counter will advance on every internal access, can provide multiple pseudo-random number, should any technology need such a feature.

If needed, the firmware will have the capability to encrypt data with a key of an appropriate length kept in write-only or write-once-only group media area using any good algorithm like NIST approved AES. There may also be capability to generate Message Authentication Code (MAC) like Keyed-Hashing MAC called HMAC, (as per internet RFC 2104) with a key of an appropriate length kept in the write-only or write-once-only groups media area. Such encryption or MAC generation can be of pure software implementation and may not need hardware engine since authentication unlike storage data encryption does not operate on large data blocks nor does it takes place as often.

Extended commands can easily be provided for the server to authenticate the device or the device to authenticate the server by challenge response method using shared keys kept in write-only or write-once-only group media area. The encryption and MAC capability can be used by the authentication server programs to interact with the device in a secure manner by way of OTP (One time Password) or challenge response method or any other method like PKCS by RSA etc.

One possible embodiment may provide support for the Open Authentication (or OATH) method of HOTP (HMAC One Time Password) technology. For this purpose one may keep the secret key and the counter as needed in that technology in either write-only or write-once-only group media. There will be an extended command to fetch the HOTP number for the corresponding verifying entity or authentication server program. If multiple authentication servers keep their data in this device, then user may have to choose one or the client program may choose one based the authentication server. In response to such a command from the host computing device, the device will locate the right key and the counter, increment the counter, will calculate the HOTP as outlined the OATH specification using the HMAC capability of the device and provide the host with the HOTP.

People skilled in this art, will understand that initialization protocol like CT-KIP of RSA or XKMS etc. can easily be supported with appropriate extended commands.

The People, who are skilled in this art, will understand that adding the above features will not need any hardware redesign for an existing storage device and can be done with just the firmware modification as long as the there is enough additional space for storing additional firmware the extended commands will demand.

### MALICIOUS ATTACKS AGAINST EXTENDED DEVICES

People skilled in this art will be able to appreciate the fact apart from the weaknesses, if any, associated with the algorithms used for provisioning/initializing and managing authentication, the extended device when implemented as explained above does not by itself introduce any degradation of security and can fully match any other USB token or OTP device. With proper mechanical, electrical and software implementation, those skilled in this art can understand that the extended device can also meet the NIST standard FIPS 140-2.

I claim:

1) A method by which a server program running in a computing device can use, for authentication purposes, a standard storage device connected to a second computing device which is, in turn, connected with the first computing device through networking, by keeping a “server assigned dynamic random device ID” in a file in the storage device under a folder named after “unique server string” with the help of client program running in the first computing device,

2) A method as in claim 1, where the file holding “server assigned dynamic random device ID” is encrypted by a user password,

3) A method as in claim 1, where the file holding “server assigned dynamic random device ID” is stored in area which is kept secure by password or other means by other programs,

4) A method as in claim 1, which can provide authentication without prior installation of any software on the computing device to which the said storage device is connected in those operating systems which can auto-launch programs from the said storage device,

5) A method implementing a plurality of extended commands for storage devices so that the available media can be divided into a plurality types of storage media by a computing device to which such storage devices are attached with each type of storage media having different feature sets including but limited to normal read-write available to the host computing device using regular SCSI read and write commands, read-only available through extended SCSI commands, read-after-authentication-only through extended SCSI commands, write-only through extended SCSI commands, write-after-authentication-only through extended SCSI commands, read-write through extended SCSI commands, read-write-after-authentication-only through extended SCSI commands and the said plurality of media types are distributed over one or more SCSI LUN's and over one or more media hardware in any order, each such media type using either consecutive sectors of storage or using sectors distributed in any other way anywhere,

6) A method as in claim 5 also providing additional extended SCSI commands to implement the needs of security algorithms like AES, MAC, PKI etc. demanded by various authentication protocols while utilizing the media for keeping shared secrets, public-private keys, digital certificates that are needed for the above protocols,

7) An apparatus that implements methods as in claims 5 and 6 which is a storage device implementing standard SCSI commands, has either disabled the firmware upgrade or controls the firmware upgrade in any secure manner so that unauthorized upgrades or change of firmware will not be permitted, and which may not need any additional hardware support, nor additional power, nor additional speed other than those needed for supporting regular standard SCSI commands,

8) An apparatus as in claim 7, whose different media types have at least one type that is of standard SCSI media to which all normal writing and reading is permitted from the host computing device to which it is connected and also have at least another kind of media for managing all the other kinds of media and storing authentication data and their details,

9) An apparatus as in 8, which provides extended SCSI commands to control the sizes of each kind of media and can optionally control such operation with a password based login as explained in SCSI SBP-2 specification for access control with possible different implementation for master password from the SCSI SBP-2,

10) An apparatus as in claim 8, whose different media types have at least one type an additional type of media to which the host computing device can write any number of times but cannot read the data in it but authentication software routines implemented in firmware can use the data for any purpose including encryption/decryption and the said type of media can be one separate single segment or distributed for use by many authentication verifying entities,

11) An apparatus as in claim 9, in which writing to or reading from the said media type in claim 9 is controlled either by authentication based on challenge-response method or Open Authentication based OTP method password based login as explained in SCSI SBP-2 specification for access control with possible different implementation for master password from the SCSI SBP-2,

12) An apparatus as in claim 10, whose different media types have at least one type an additional type of media to which the host computing device can write only once by but can never be read from the computing device and the said type of media can be one separate single segment or distributed for use by many authentication verifying entities,

13) An apparatus as in claim 12, in which writing to the said media in claim 11 is controlled by password based login as explained in SCSI SBP-2 specification for access control with possible different implementation for master password from the SCSI SBP-2,

14) An apparatus as in claim 4, whose different media types have at least one type that is of standard SCSI media to which all normal writing and reading is permitted from the host computing device to which it is connected and also have at least another kind of media for providing storage for managing and storing authentication data from authentication server which is connected to the host computer, and said authentication data having entries with different features like write-once-only which can be written from host only once but can not be read, write-only which can be written from host any number of times but can not be read, write-read area which can be read and written by host,

15) An apparatus as in any claim from 8—14, which can provide authentication without prior installation of any software on the computing device to which the said storage device is connected without any administrator or super user rights and which can auto-launch programs from the said storage device and implements various authentication protocols.

16) A system employing methods in one or more of the claims from 1 to 6 or employing one or more apparatuses as in claims 7 to 15 which can provide enhanced services like user two factor or strong authentication for user sign-on to computing devices or web applications like e-commerce, authentication for Software Copy Protection dongles and authentication for differentiating storage devices themselves for allowing to get recognized for further use or denied from getting recognized.

17) A system employing methods in one or more of the claims from 1 to 6 or employing one or more apparatuses as in claims 7 to 15 which can provide authentication for enabling receipt and storing in an appropriate feature set media explained in claim 5 and forwarding to other computing devices Digital Rights Management enabled, protected and encrypted contents like audio, video, e-books and similar information.
